(19) United States
(12) Patent Application Publication
(10) Pub. No.: US 2024/0013418 A1
(43) Pub. Date: Jan. 11, 2024

(54) Automated Device for Anthropometric Measurements

(71) Applicants: Megan M. Kozub, King George, VA (US); Brandon K. Marine, Fredericksburg, VA (US); Tyler J. Ferro, King George, VA (US); Nicholas A. Sievert, III, Henrico, VA (US); Christopher R. Cheatham, Fredericksburg, VA (US); William E. Friend, Mechanicsville, VA (US)

(72) Inventors: Megan M. Kozub, King George, VA (US); Brandon K. Marine, Fredericksburg, VA (US); Tyler J. Ferro, King George, VA (US); Nicholas A. Sievert, III, Henrico, VA (US); Christopher R. Cheatham, Fredericksburg, VA (US); William E. Friend, Mechanicsville, VA (US)

(73) Assignee: United States of America, as represented by the Secretary of the Navy, Arlington, VA (US)

(21) Appl. No.: 18/140,380

(22) Filed: Apr. 27, 2023

Related U.S. Application Data
(60) Provisional application No. 63/343,854, filed on May 19, 2022.

(51) Int. Cl. G06T 7/60; G06T 7/73

(52) U.S. Cl. CPC G06T 7/60; G06T 7/74; G06T 2207/10012; G06T 2207/30196

(57) ABSTRACT

A measurement system is provided for assessing dimensions of a human body. The system includes a stereoscopic camera, and an autonomous processor. The camera captures the body standing from front and side perspectives. The processor identifies reference points corresponding to extremity locations and joints on the body. The processor further calculates distances between the reference points and determining the dimensions for output and subsequently estimates a pose envelope from the distances. The processor then compares the pose envelope to confinement restraints for predicting anthropometric conformity to the restraints. A computer-implemented method performing operations by the processor is also provided.

### CROSS REFERENCE TO RELATED APPLICATION

Pursuant to 35 U.S.C. § 119, the benefit of priority from provisional application 63/343,854, with a filing date of May 19, 2022, is claimed for this nonprovisional application.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to anthropometric measurement. In particular, the invention relates to automated determination of physiological dimensions of a human body for comparison to confined spaces such as an aircraft cabin seat.

### SUMMARY

Conventional anthropomorphic measurement techniques yield disadvantages addressed by various exemplary embodiments of the present invention. In particular, various exemplary embodiments provide a measurement system for assessing dimensions of a human body. The system includes a stereoscopic camera and a processor that executes a key-point detection algorithm and a prediction model. The camera captures images of the body standing from front and side perspectives.

The key-point detection algorithm identifies reference points corresponding to extremity locations and joints on the body. The prediction model utilizes distance data extracted from the key-point detection algorithm, combined with the 3D data provided from the camera, and provides the predicted measurements. These measurements are also compared to a provided database for predicting anthropometric conformity to the restraints. Other various embodiments provide a computer-implemented method performing operations by the processor.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a graphical user interface (GUI) view of a frontal image;

FIG. 2 is a GUI view of a lateral image;

FIG. 3 is a GUI view of frontal and lateral images;

FIG. 4 is a GUI view of body images identifying position points;

FIG. 5 is a GUI view of comparison scales for body dimensions;

FIG. 6 is a plot set of a parameter variation distributions;

FIGS. 7A, 7B, 7C and 7D are a set of tabular views of dimensions;

FIG. 8A is a GUI view of a body images with dimension list;

FIG. 8B is a set of images for anthropomorphic comparison;

FIG. 9A is a flowchart view of an exemplary ADAM sequence;

FIG. 9B is a block diagram view of an exemplary ADAM system;

FIG. 10 is a flowchart view of an image capture process;

FIG. 11 is a flowchart view of a pose estimation process; and

FIG. 12 is a flowchart view of an anthropometry prediction process.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component.

The disclosure generally employs quantity units with the following abbreviations: length in millimeters (mm), mass in kilograms (kg), time in seconds (s), angles in degrees (°), force in newtons (N), energy in joules (J), and gigabytes (GB). Supplemental measures can be derived from these, such as density in grams-per-cubic-centimeters (g/cm³), moment of inertia in kilogram-square-meters (kg-m²) and the like.

Technology: The Automated Device for Anthropometric Measurements (ADAM) is a system developed by Naval Surface Warfare Center Dahlgren Division (NSWCDD) for automatically predicting five target anthropometric measurements (stature, sitting height, sitting eye height, buttock knee length, and thumb-tip reach) of an individual. ADAM Phase II builds upon successes of an initial prototype developed during an initial Phase I.

At a high level, ADAM uses a depth-sensing camera and artificial neural networks to identify joint locations and features from a pair of three-dimensional (3D) images of a participant, then uses those features to predict the target anthropometric measurements. The predicted anthropometric measurements can then be used for qualifying Student Naval Flight Officer (SNFO) or Student Naval Aviators (SNA) to fit into various aircraft.

ADAM utilizes a combination of neural networks to parse an image of a person, automatically detect a series of key-points on that human body and provide details about the person's physiology. This application of computer vision can further enhance the field of human-machine teaming through more naturalistic methods of communication between the human and an automated system.

The ADAM System is subdivided into hardware and software components. The hardware is comprised of a ZED2 stereo depth camera and laptop. The ZED2 depth camera provides 3D (XYZ) depth data, in addition to high resolution Red Green Blue (RGB) images, both of which are critical in capturing the data from an individual in order to predict the target anthropometric measurements. The laptop contains an Nvidia graphics card (with compute capability >3.0) which facilitates two functions: the ZED2 depth camera requires such a graphics card to function properly and the underlying ADAM software is dependent on the graphics card for faster processing.

The exemplary ADAM software can be adjusted to utilize the CPU for slightly slower processing, but it takes advantage of the GPU because it is required by the ZED2 depth camera. Optionally, the ADAM System can utilize a tripod, or similar mounting device, for consistent, stable mounting of the ZED2 depth camera, but is not required. A tripod is optional for the ADAM system. Depending on the environment, the ZED2 camera may be optimal when disposed on a table adjacent a laptop that executes the software code.

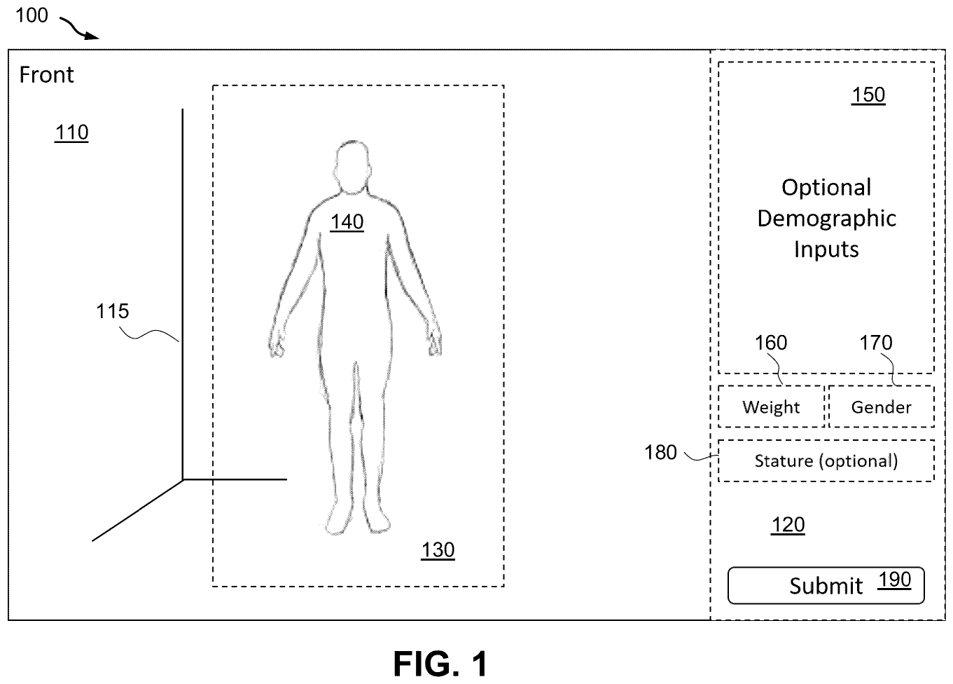

FIG. 1 shows a GUI screen view 100 of a front image frame 110 and an inputs window 120. The frame 110 displays a feed of the camera with a specified visual region 115 depicting a room defined by wall and floor edges. A male participant (in this example) stands within this region 115 for purposes of capturing a front image 130 on display in the frame 110. As a human body 140, the participant is instructed to stand in a natural position facing the camera. The front frame 110 includes optional demographic inputs 150, as well as weight 160, gender (i.e., biological sex) 170 and stature 180, together with a submit button 190 after all relevant information has been subsequently supplied. The participant's front view has been captured and the side view is prepared for capture. As yet, no participant information has been entered in the window 120.

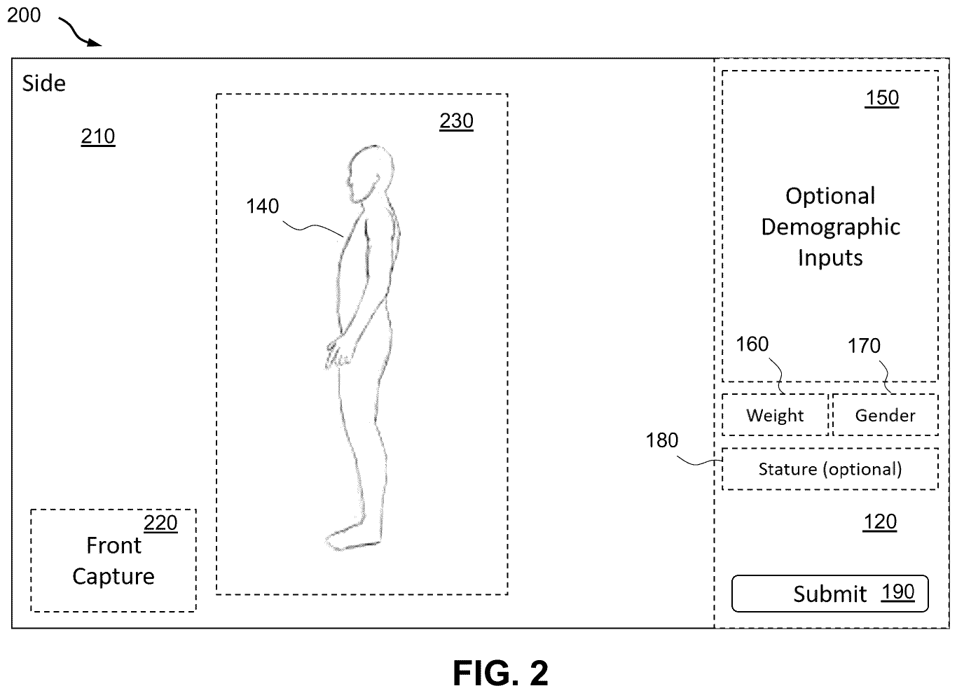

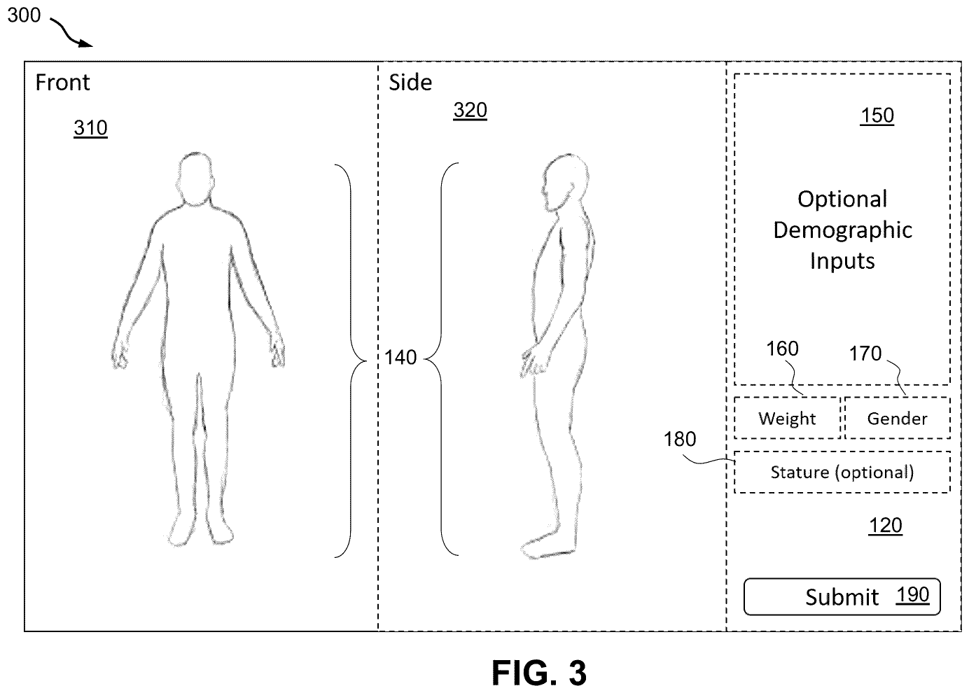

FIG. 2 shows a GUI screen view 200 of a side image frame 210 together with the inputs window 120. The participant is instructed to turn his (or her for a female) body 140 from facing front and face perpendicular to the camera with arms ahead of the hips. The frame 210 features a reduced image 220 of the front capture of image 130 along with the current camera feed and the specific visual region in which the participant stands for capturing a side image 230. The same demographic inputs window 120 from view 100 remains shown. FIG. 3 shows a GUI screen view 300 of a front image frame 310 and a side image frame 320 both showing the body 140 from separate perspectives together with the inputs window 120. The inputs 150 and submit button 190 correspond to view 100.

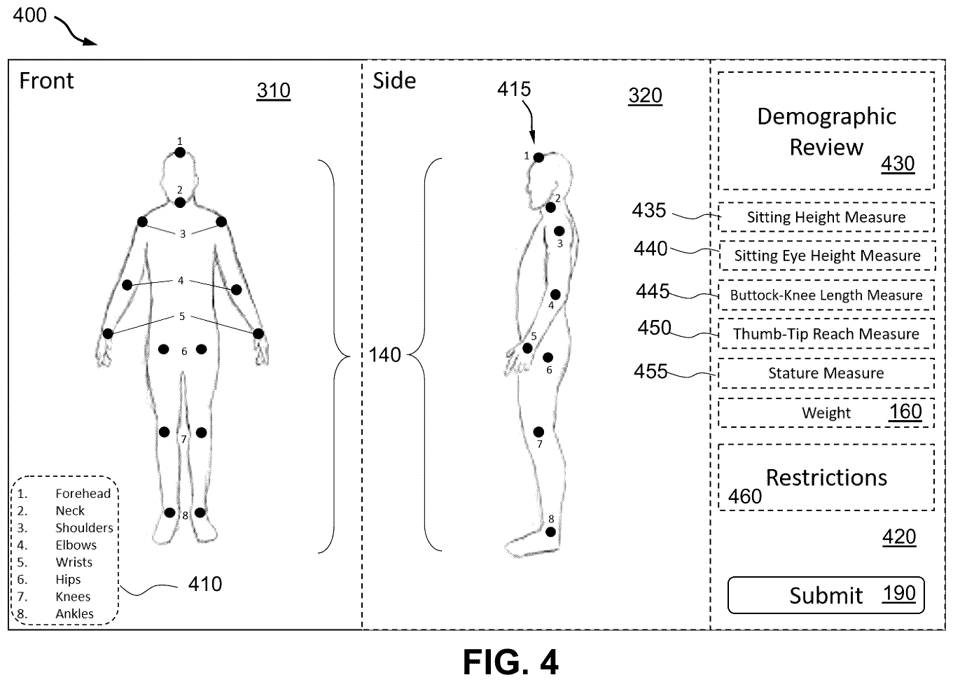

FIG. 4 shows a GUI screen view 400 of the front and side captures 310 and 320. For purposes of exposition, a location list 410 is presented that corresponds to numbered topological positions 415 on the body 140. These anatomical points include (1) forehead, (2) neck, (3) shoulders, (4) elbows, (5) wrists, (6) hips, (7) knees and (8) ankles. An inputs window 420 includes a parameter summary as a demographic review 430, which includes sitting-height measure 435, sitting eye-height measure 440, buttock-knee length measure 445, thumb-tip reach measure 450, stature measure 445, weight 160 (as a non-visual parameter) and restrictions 460, accompanied by the submit button 190 or else an updated options selection for export of the data, review of scales or start over command. This selection feature is merely exemplary and not limiting.

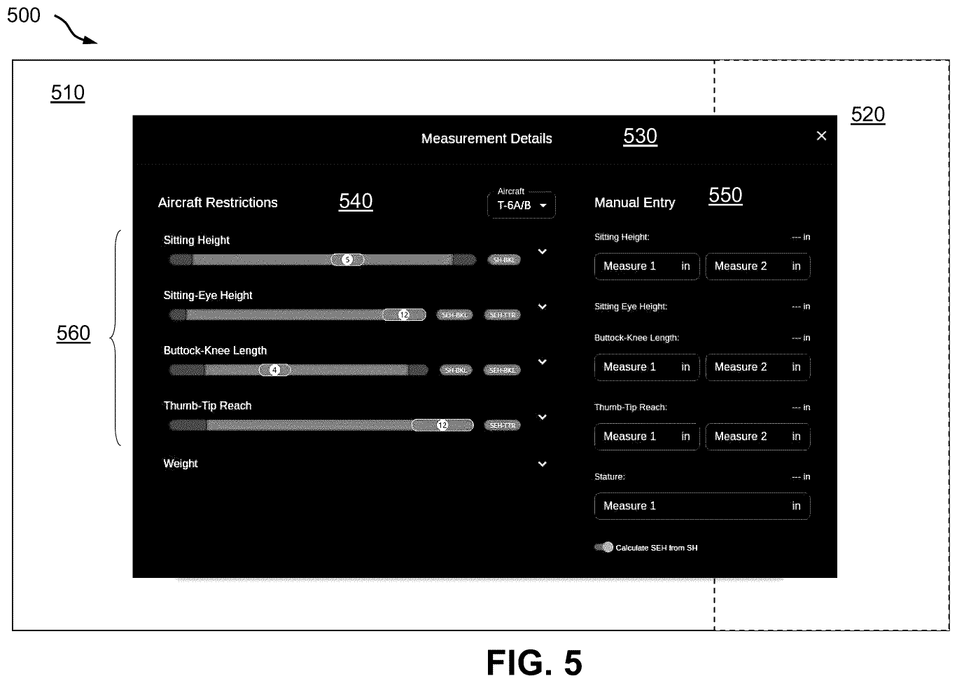

FIG. 5 shows a GUI screen view 500 of divided windows 510 and 520 that present measurement details 530. These include aircraft restrictions 540 as a set of limitation parameters for acceptable dimensions for a body 140 in an aircraft cabin, and optional manual entry fields 550 for provided input values. The restrictions 540 include analog scales 560 to illustrate measured parameters for the body 140 in comparative context with their aircraft acceptance ranges. These include sitting height 435, sitting eye height 440, buttock-to-knee length 445 and thumb-tip reach 450.

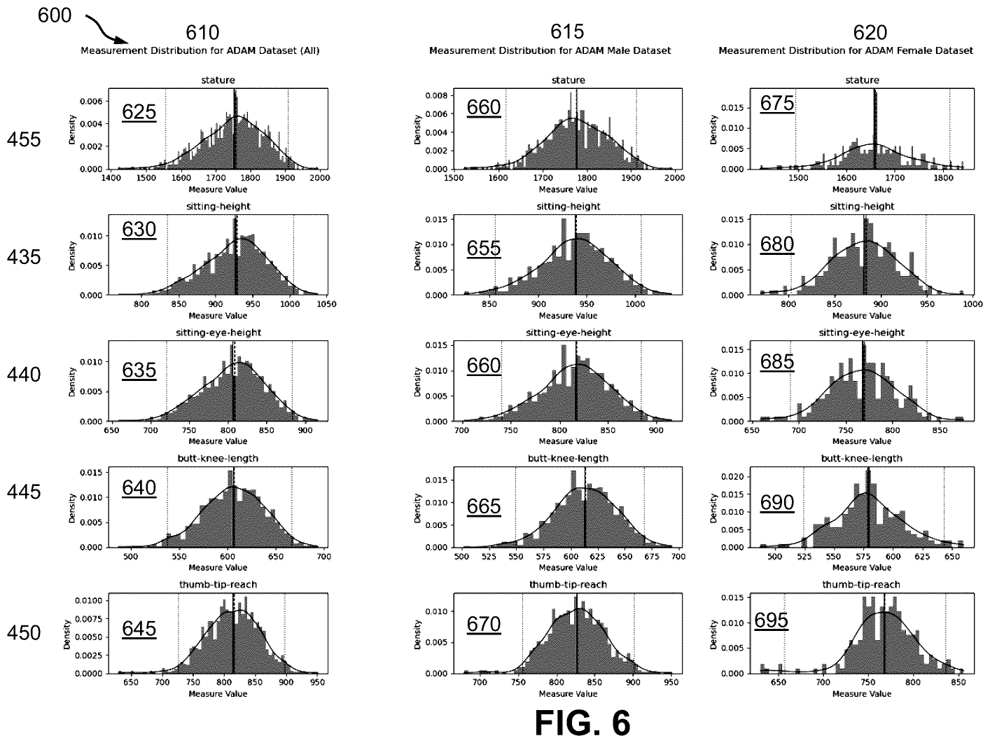

FIG. 6 shows a set of plot views 600 of density histograms of measurement distributions from ADAM datasets. The histogram plots are presented in three human dataset columns: all (adults) 610, male 615 and female 620, and listed along five rows: stature 455, sitting height 435, sitting eye-height 440, butt-knee length 445 and thumb-tip length 450. The all column 610 includes plots 625, 630, 635, 640 and 645 in the row order. The male column 615 includes plots 650, 655, 660, 665 and 670 in the row order. The female column 620 includes plots 675, 680, 685, 690 and 695 in the row order. These plots 600 show a population values for these measurement parameters in gray vertical bands, a median column in a dark column, and a smooth roughly Gaussian distribution in black outline.

The software is broken down into two main components: the GUI and the prediction algorithms. Frequent interactions with the Naval Air Schools Command (NASC) Pensacola Anthropometric Model Manager enabled design and development of a GUI that fits the needs of the intended end-users as operators. The GUI requires no specialized training and minimizes operator interaction.

The basic sequence of actions the operator performs with the GUI are: the operator launches the ADAM software, optionally enters information about the body 140 of a participant, instruct the participant how to stand/position the participant within the view of the ZED2, captures front and side perspectives of the body 140, enters required information about the participant, submits the data for processing, reviews the predicted measurements, enters any desired manual measurements, and exports the data, after completion of that process. Additional features in the GUI enable the operator to maintain a database of aircraft restrictions and training pipelines, change color themes, exploit keyboard shortcuts for performing actions, and retaking front or side view captures.

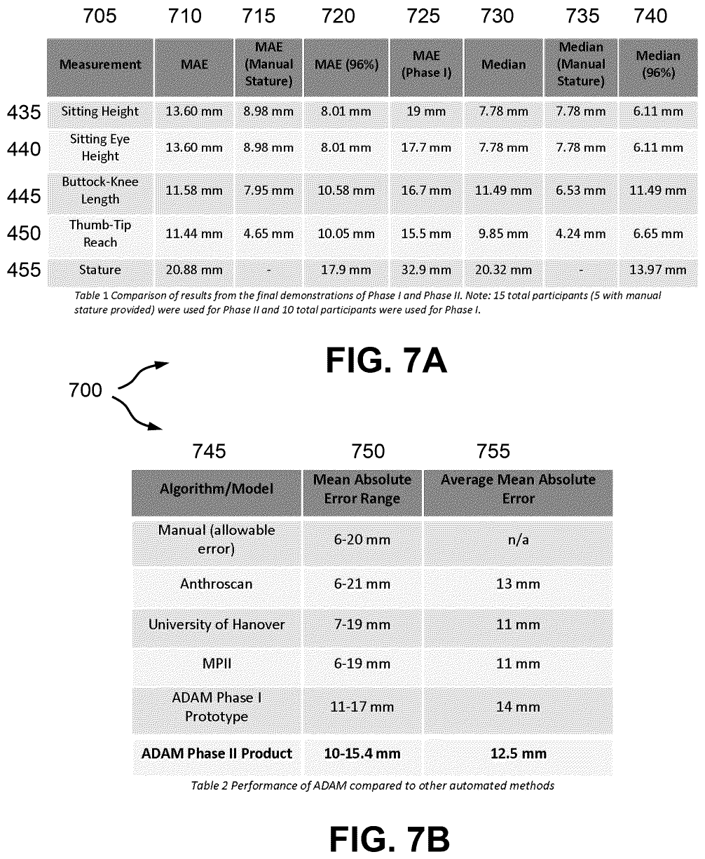

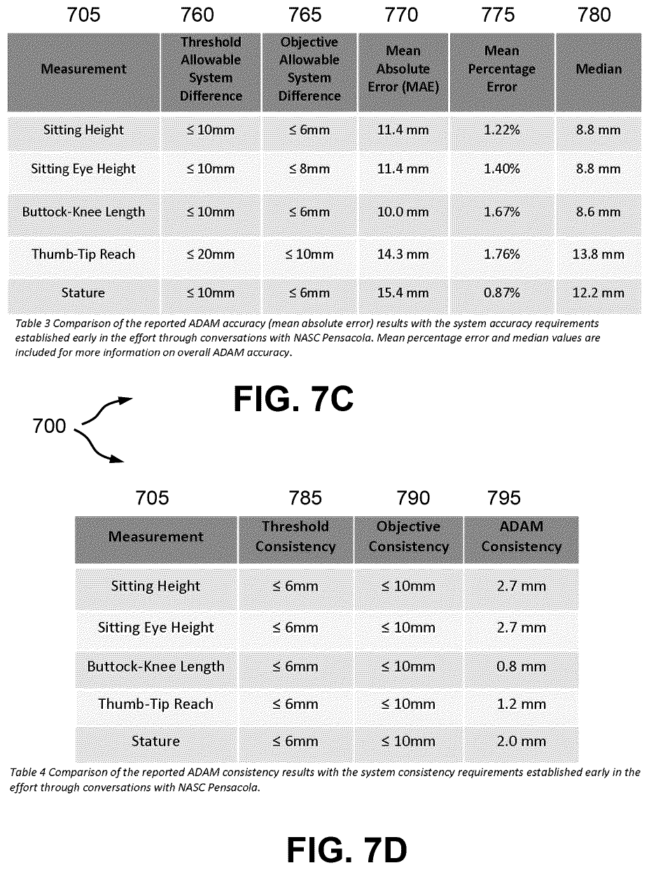

FIGS. 7A, 7B, 7C and 7D show a set of tabular views 700 featuring columns of measured values (in millimeters). Table 1 as FIG. 7A includes a measurement parameter column 705, accompanied by mean absolute error (MAE) 710, stature 715, MAE 96% 720, Phase I 725, median 730, manual median stature 735 and median 96% 740. Parameter column 705 holds rows sitting height 435, sitting eye-height 440, buttock-knee length 445, thumb-tip reach 450 and stature 455.

Table 2 as FIG. 7B includes an algorithm model column 740, accompanied by mean absolute error range 745 and average mean module error 750. Table 3 as FIG. 7C includes the parameter column 705, accompanied by threshold acceptable difference 760, objective acceptable difference 765, MAE 775 and medium 780. Table 4 as FIG. 7D includes the parameter column 705, accompanied by threshold consistency 785, objective consistency 790 and ADAM consistency 795.

Table 1 as FIG. 7A compares results from the final demonstrations of Phase I and Phase II. A total of fifteen participants (five with manual stature provided) were used for Phase II, and ten total participants were used for Phase I. Table 2 provides performance of ADAM compared to other automated methods. These alternatives are manual (allowable error), Anthroscan, University of Hanover, Max Planck Institut Informatik (MPII), ADAM Phase I Prototype and the exemplary ADAM Phase II Product. Thus ADAM Phase II shows comparable error bands to competing alternatives, which are far less convenient and more expensive to implement.

A brief detailing final product specifications and results were provided between measuring of participants. Four MAE values 710, 715, 720 and 725 and three median values 730, 735 and 740 are compared to show different situations. Manual Stature refers to cases where stature 455 was provided as an input into ADAM. MAE 96% 720 refers to the cases that all fall within ADAM's confidence range. Outside of this range, ADAM would notify the operator to provide manual measurements.

Table 3 provides a comparison of the reported ADAM accuracy as mean absolute error (MAE) results with the system accuracy requirements established from conversations with NASC Pensacola. Mean percentage error and median values are included for more information on overall ADAM accuracy. Table 4 provides a comparison of the reported ADAM consistency results with the system consistency requirements established early in the effort through conversations with NASC Pensacola.

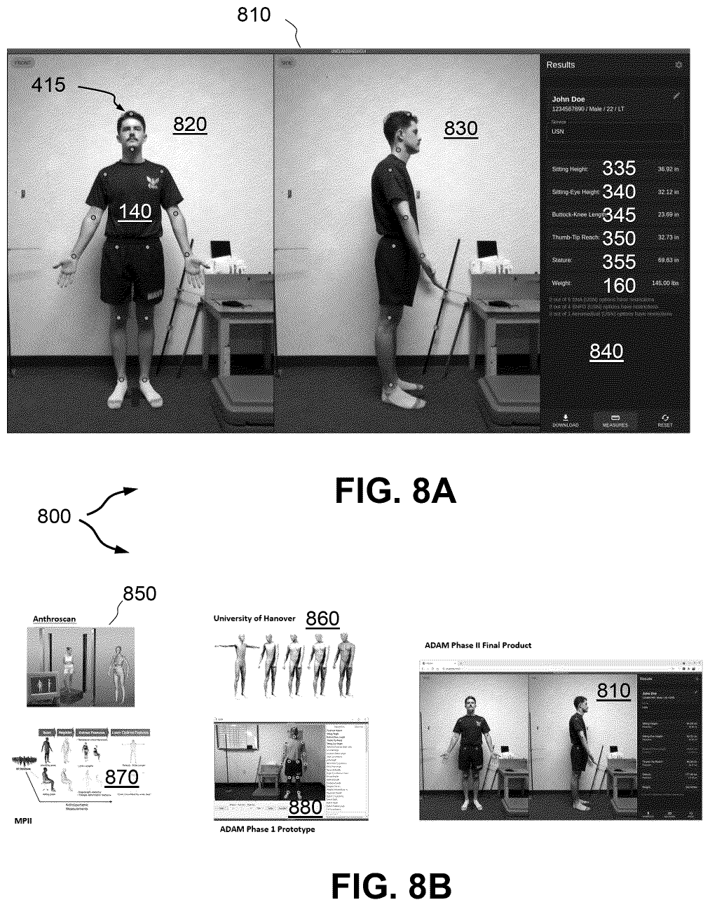

FIGS. 8A and 8B show GUI and comparative views 800 of ADAM Phase II software results 810 for a body 140 of “John Doe” as the participant. Windows 820 and 830 present visual results of the exemplary ADAM software for their respective front and side perspectives. The points 415 (identifying joints) of the participant are visible as bright markers on the RGB images. There are no restrictions for aircraft occupancy given the predicted anthropometric measurements. Window 840 identifies the measured parameters, including stature 355 and weight 160. The results can be compared to images for Anthroscan 850, University of Hanover 860, MPII 870, ADAM Phase I 880 and the exemplary ADAM Phase II 810.

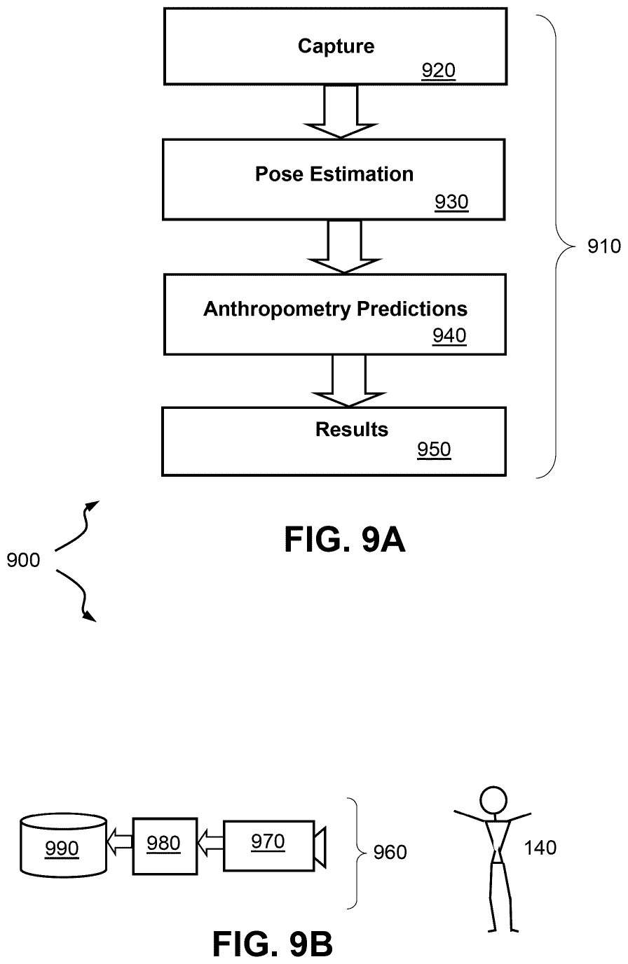

FIGS. 9A and 9B show flowchart and block diagram views 900 of ADAM. FIG. 9A features an exemplary ADAM analysis sequence 910. This includes a capture process 920, a pose estimation process 930, an anthropometry prediction process 940 and a results incorporation process 950, which integrates the measured and analyzed anatomical information to determine conformal compatibility of the body 140 to an aircraft cabin's dimensional constraints.

FIG. 9B illustrates a block diagram of an ADAM system 960. A camera 970 captures an image of the participant's body 140 and supplies that image to an autonomus processor 980 that executes a key-point detection algorithm and a prediction model. The detection algorithm identifies a plurality of reference points 415 corresponding to extremity locations and joints on the image 130, 230 of the body. Multiple images can be amalgamated from the camera 970 for a cumulated set of reference points 415. The processor 980 further calculates distances between these reference points 415. Further analysis can be performed to compare the dimensions to confinement spaces to estimate conformance of the body 140 within such spaces. Such conformance results can be stored as a file in memory 990, although physical and identifiable parameters for individual persons is deleted to reduce risk of fraudulent exposure.

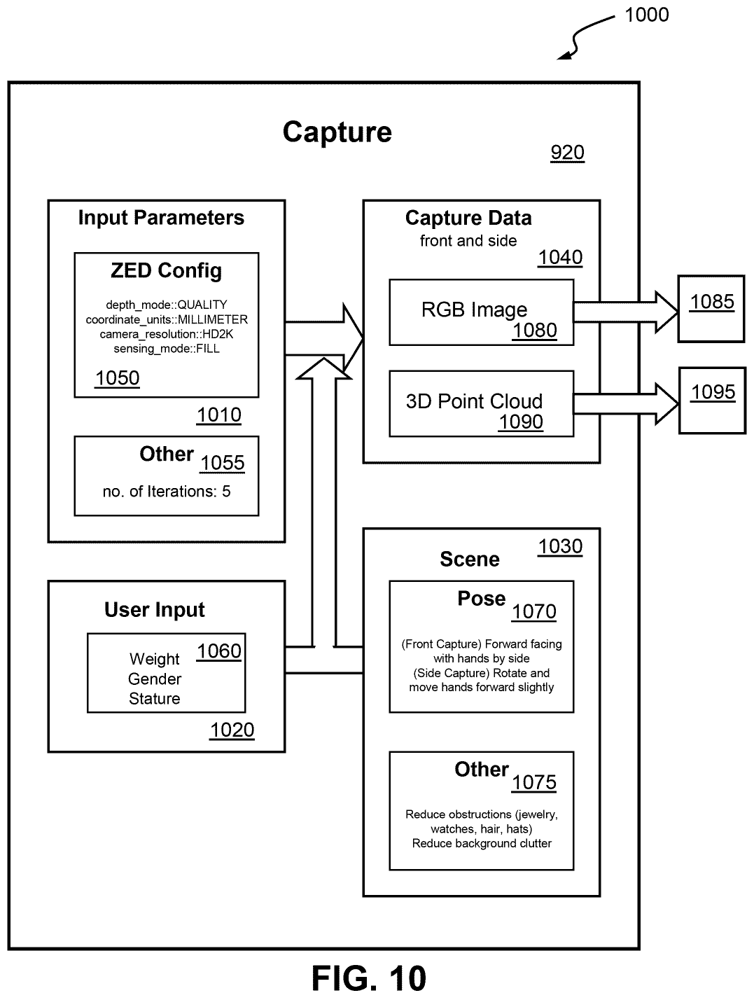

FIG. 10 shows a flowchart view 1000 of the capture process 930. These modular operations include input parameters 1010, user input 1020 and scene 1030 that supply information to capture data 1040. The input parameters 1010 include ZED configuration 1050 and other inputs 1055, such as number of iterations. The operator input 1020 includes operator supplied entries 1060, such as weight, gender (i.e., visually-determinable sex) and stature. The scene 1030 includes anatomical positioning 1070 (e.g., orientation of torso and extremities) and other 1075 to minimize background distractions and clutter. The capture data 1040 includes RGB image 1080 that provides image output 1085 (front and side) and 3D point cloud 1090 that provides point information 1095. The point cloud 1090 constitutes a large series of individual points plotted in Cartesian space that represent the general 3D dimensions of the participant or other object in view of the camera 970.

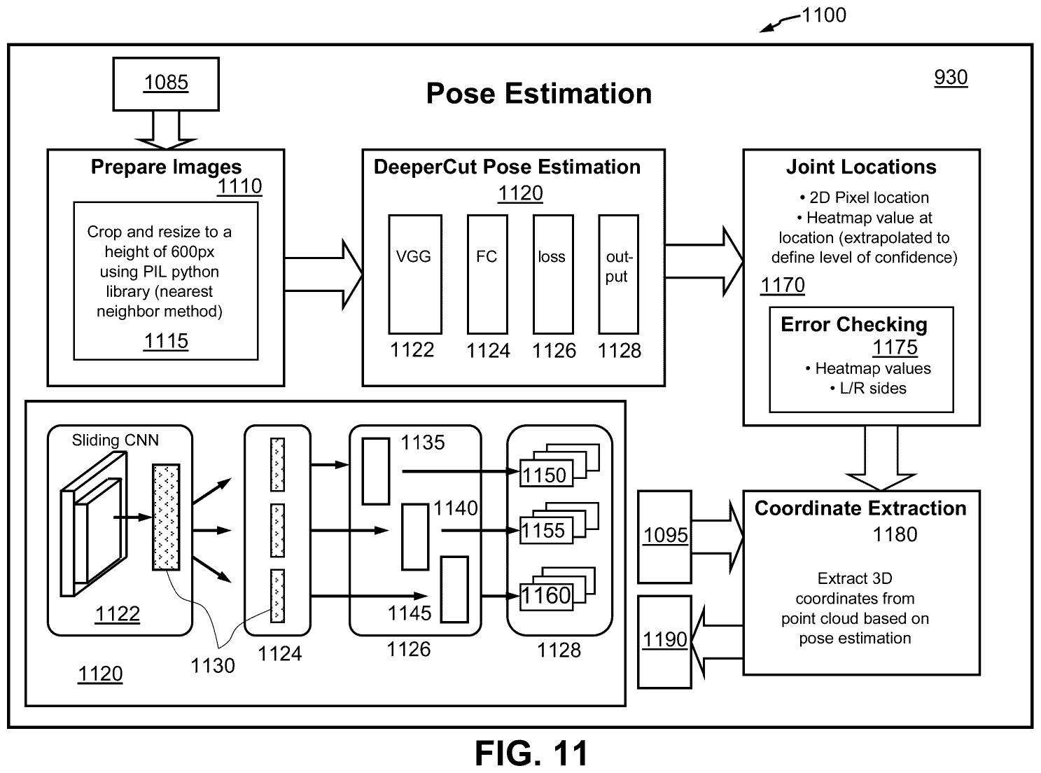

FIG. 11 shows a flowchart view 1100 of the pose estimation process 930. These modular operations include prepare images 1110 with crop and resize feature 1115 responsive to receiving image output 1085. The image preparation passes to DeeperCut post estimation 1120 that includes sliding convolutional neural networks (CNN) 1122, fully connected (FC) 1124, loss functions 1126 and dense outputs 1128. The CNN 1122 features conversion mapping from visual geometry group (VGG) to FCs 1124 subdivided into loss functions 1126 as cross-entropy, self-regression and pairwise regression. These loss functions 1126 provide values to the dense functions 1128, including scoremaps, unary vector fields and pairwise vector fields. Note that VGG is a human pose estimation dataset that DeeperCut used to generate their models, while FC is a fully connected layer of the neural network.

The estimation 1120 operation is also illustrated as Revision at https://ichi.pro/es/revision-deepcut-deeperct-estimacion-de-pose-de-varias-personasestinacion-de-pose-humnia-240085561555907 from ICHI. See also http://huinanpose.mpi-inf.mpg.de/contents/andriluka14cvpr.pcdf and http://human-pose.npiinfmpg.de/contents/pishchulin14gcpr.pdf as technical references. In detail, the estimation 1120 translates the CNN to a plurality of FC entities 1130.

These separate FCs 1124 are provided to cross entropy 1135, self regression 1140 and pairwise regression 1145 among loss functions 1126, which in turn are correspondingly supplied to score-maps 1150, unary vector fields 1155 and pairwise vector fields 1160 within dense outputs 1128. Pose Estimation 1120 supplies Joint Locations 1170 with 2D pixel location and heatmap value, as well as error checking 1175. These values are supplied to Coordinate Extraction 1180 that receives input from image output 1085 and submits results 1190 as 3D Cartesian positions. These results 1190 are derived from combining 2D joint locations with the 3D point cloud 1090.

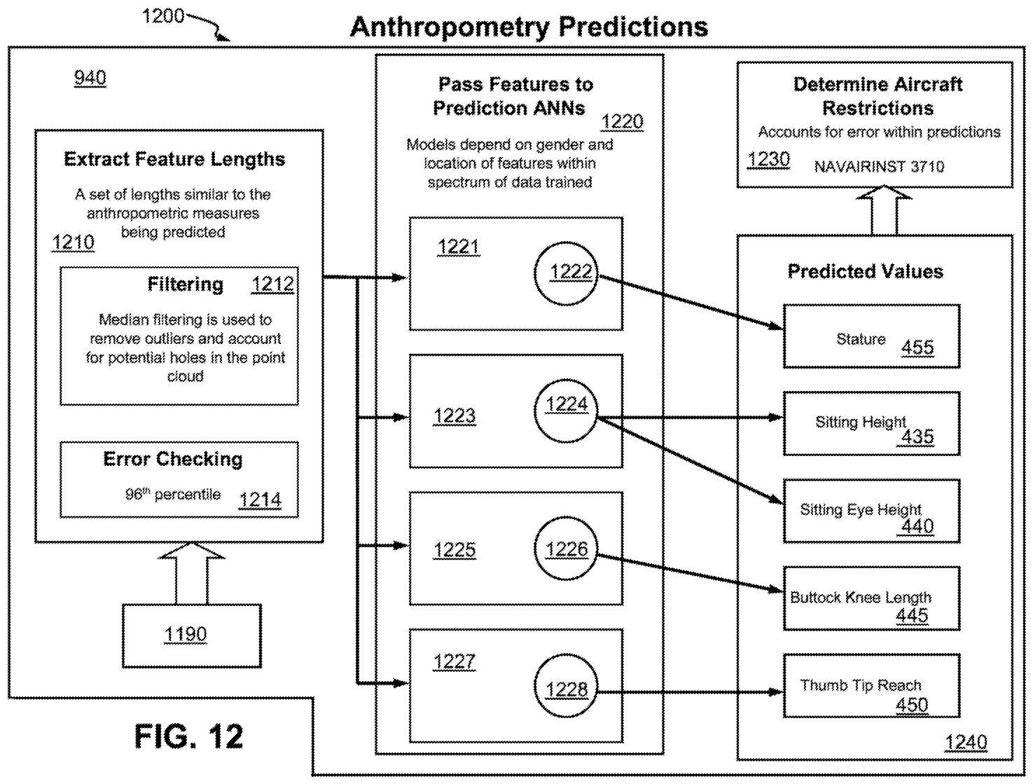

FIG. 12 shows a flowchart view 1200 of the anthropometry prediction process 940 in relation to an artificial neural network (ANN). Results 1190 provide input to Extract Feature Lengths 1210 for a set of lengths similar to anthropometric measures being predicted that further includes Filtering 1212 to remove outliers and account for potential gaps in the point cloud 1090 via Error Checking 1214. The extract lengths process 1210 provides features to predict ANNs 1220. These ANN modes depend on gender and location of feature within spectrum of data trained algorithm.

This includes first parameters 1221 with stature ANN 1222, second parameters 1223 with sitting height ANN 1224, third parameters 1225 with buttock-knee length ANN 1226; fourth parameters 1227 with thumb-tip reach ANN 1228. Aircraft Restrictions 1230 are based on NAVAIRINST 3710. See https://www.dcma.mil/Portals/31/Documents/Aircraft%20Operations/4DCMAI_8210.1B_Contractor%27s_Flight%20and_Ground_Operations_1_March_2007.pdf for reference.

The first parameters 1221 include forehead-ankle length, neck-ankle length, weight, hip breath and shoulder breadth. The second parameters 1223 include forehead-hip length, shoulder-hip height, stature and weight. The third parameters 1225 include hip-knee length, knee-ankle length, shoulder-hip height, stature and weight. The fourth parameters 1227 include wrist-elbow length, elbow-shoulder length and stature. Predicted values 1240 provide input to the Aircraft Restrictions 1230 and include stature 455 that receives input from stature ANN 1122, sitting height 435 and sitting eye-height 440 that receive input from sitting height ANN 1224, buttock-knee length 445 that receives input from buttock-knee ANN 1226, and thumb-tip reach 450 receives input from thumb-tip reach ANN 1228. The results 950 include the predicted measurement outputs 1220 and the restrictions generated from known documented aircraft restriction tables 1230. These results are displayed to the operator in windows 420 and 840.

To summarize, ADAM provides a measurement system 960 for assessing dimensions of a human body 140. The ADAM system 960 includes a stereoscopic camera 970 and an algorithm and model processor 980. The analysis operations include the key-point detection algorithm for geometric distance calculations from reference points 415 on the body 140 and the prediction model to compare those distances to compatibility with a confinement space employing the analysis sequence 910. The camera 970 captures the body 140 standing from front and side perspectives. The processor 980 determines predicted measurements from the distances, and also compares the predicted measurements to confinement restraints for predicting anthropometric conformity to those restraints for output results 950 for subsequent saving to memory 990.

The first operation in the prediction algorithms for ADAM process 910 involves analyzing the captured windows 110 and 210 (front and side) to identify 3D joint locations as points 415 of the participant's body 140. When the operator selects capture on the GUI, five sequential frames are captured to account for subtle changes in the depth feed from the camera 970, such as ZED2. On occasion, the ZED2 may miss information for a particular pixel due to shadowing or other effects.

The ADAM process 910 employs the DeeperCut algorithm 1120 to process the frames 110 and 210 from the front and side views. DeeperCut incorporates those frames 110 and 210 as inputs, and provides the joint locations as points 415 on the RGB image as outputs 1085, together with their corresponding pixel values, which used by the anthropometric measurement prediction algorithm 940.

DeepCut and DeeperCut were originally developed by Max Planck Institute of Informatics together with Stanford University. The latter technique is described by E. Insafutdinov et al., “DeeperCut: A Deeper, Stronger, and Faster Multi-Person Pose Estimation Model” for the European Conference on Computer Vision ECCV 2016 (34-50)—for additional details, see conference paper https://link.springer.com/chapter/10.1007/978-3-319-46466-4_3 and preprint https://arxiv.org/pdf/1605.03170 as references. Additional literature includes https://arxiv.org/pdf/1511.06645 and https://arxiv.org/abs/1612.01465 for reference.

The exemplary ADAM software then calculates joint-to-joint lengths, which are used as features in the anthropometric measurement prediction algorithm. The ZED Software Development Kit (SDK) provides the ability to convert pixel location (2D/XY coordinates in the RGB images) into 3D (XYZ) coordinates (in the point clouds). The 3D coordinates have an origin at the center of the left lens on the ZED2 depth camera and have a unit of millimeters (by default).

The Euclidian distance between points 415 can be determined upon completion of this conversion by employing the standard Euclidian distance formula for three-dimensional space, shown as:

D=\sqrt{(x₁−x₂)²+(y₁−y₂)²+(z₁−z₂)²},

where D is the distance between two points (x₁,y₁,z₁) and (x₂,y₂,z₂) in Cartesian coordinates.

Then, the individual features (i.e., radiale stylion length, shin length, etc.) of each frame are filtered in order to remove any outliers (beyond one standard deviation) caused by an inaccurate joint prediction in the DeeperCut network or errors in the ZED point cloud. After filtering, the median of each feature is then supplied to an Artificial Neural Network (ANN), developed internally using data collected by NASC Pensacola and Naval Air Warfare Center Aircraft Division (NAWCAD), to generate predictions for each of the five target anthropometric measurements shown in window 420.

In Phase I as image 880, ADAM used the Anthropometric Survey (ANSUR) II from the U.S. Army Natick Soldier Research, Development and Engineering Center (NSRDEC) as “2012 Anthropometric Survey of U.S. Army Personnel” by C. C. Gordon et al. for training the prediction neural network, available at hitps://apps.dtic.mil/sti/pdfs/ADA611869.pdf for reference. The translation of features extracted from DeeperCut to the ANSUR 11 dataset created challenges that were overcome by working in conjunction with the anthropometry subject matter experts at NASC and NAWCAD to label a new, custom dataset. This new dataset includes 1062 participants (822 male and 240 female), each with front and side views (2124 images).

In training the prediction neural network, the middle 96% of the dataset was used. For each feature used in predicting the anthropometric measurements, there was a relatively normal distribution within the dataset, meaning the model had less data points on the tail ends to use for making predictions as in views 600. Therefore, to improve the accuracy for the majority of the population, the upper and lower 2% of data was excluded from the data used for training the prediction model. When ADAM detects a participant falls within either tail of the distribution (upper or lower 2%), it will use a more generalized, lower accuracy model and provide an indication in the user interface for lower confidence in the prediction.

In addition to the model accuracy improvements, a level of context was included in ADAM during Phase II. Through setting up a database of aircraft restriction parameters, the ADAM System is able to take the measurements, automated or manual, and quickly display aircraft restrictions for the participant to provide indication of which training pipelines are restricted. In its current configuration, ADAM would not be used to disqualify a participant based on predicted measurements alone due to the potential for error and the consequences of such misidentification. Instead, ADAM can be used to quickly provide insight for the majority of participants. In the event that the predicted value, plus-or-minus the error values above, presents a restriction, ADAM indicates that the participant requires manual measurements.

Objectives: The primary objectives for this project are to provide consistency, accuracy, and usability improvements to the ADAM System through further development, validation, and verification. The thresholds (T) and objectives (O) for consistency and accuracy improvements to the five target anthropometric measurements are as follows:
For Sitting Height, the system shall:
   Have an acceptable system difference of less than or equal to 6 mm with less than or equal to 10 mm consistency (O).
   Have an acceptable system difference of less than or equal to 10 mm with less than or equal to 6 mm consistency (T).
For Buttock-Knee Length, the system shall:
   Have an acceptable system difference of less than or equal to 6 mm with less than or equal to 10 mm consistency (O).
   an acceptable system difference of less than or equal to 10 mm with less than or equal to 6 mm consistency (T).
For Thumb-tip Reach, the system shall:
   Have an acceptable system difference less than or equal to 10 mm with less than or equal to 10 mm consistency (O).
   Have an acceptable system difference less than or equal to 20 mm with less than or equal to 6 mm consistency (T).
For Sitting Eye Height, the system shall:
   Have an acceptable system difference less than or equal to 8 mm with less than or equal to 10 mm consistency (O).
   Have an acceptable system difference less than or equal to 10 mm with less than or equal to 6 mm consistency (T).
For Stature, the system shall:
   Have an acceptable system difference less than or equal to 6 mm with less than or equal to 10 mm consistency (O).
   Have an acceptable system difference less than or equal to 10 mm with less than or equal to 6 mm consistency (T).

In short, the objective is to have a highly accuracy system with some consistency (O). If a high accuracy is not achievable, then the system needs to be more consistent (T).

Additionally, Phase II kept within the bounds of the objectives and sub-objectives from Phase I. The objectives from Phase I fall into four categories: technical capability, ease of use, logistics (cost, maintenance, and space), and data handling. Primary objectives for each of these categories are as follows:
Technical Capability—The screening time will not exceed five minutes.
Ease of Use—The system will not require specialist training beyond what can be achieved on-the-job and will not require extensive setup.
Logistics—The cost of the final system will not exceed $3,500. The system will be easy to move and require minimal maintenance. The system will fit and operate within a 6′×8′×8′ room.
Data Handling—The system will not publish any collected personal identifying information (PII) to unauthorized individuals, networks, or computers. The process 910 enables export of measurement data for authorized use.

Demonstration: A final demonstration of the ADAM System was held at Naval Air Schools Command Pensacola on Jul. 6, 2021. For personnel unable to attend in-person, due to the COVID-19 situation, the final demonstration was also hosted via Microsoft Teams. During this event, the primary focus was a live demonstration, during which fifteen NASC student participants were measured by the ADAM process 910 and manually measured by the NASC Anthropometric Model Manager for comparison.

Quantitative Benefit Assessment—Accuracy, cost, time and usability were all important factors in developing the ADAM process 910. Conventional techniques for gathering anthropometrics include manually measuring five measurements on each individual. This conventional process can take approximately five minutes to fully measure a single participant, with a range of thirty to sixty participants needing measurements per week. These manual measurements require the participant to change their pose three times to achieve all measurements. The conventional process requires a chair (with butt plate), footstool (which must be adjusted based on the participant), and potentially a fixed measurement chart on a wall (alternatively, measurers may utilize an anthropometric ruler in place of the fixed chart). Time, manpower, and human error all are obvious points of error associated with this conventional method.

The exemplary ADAM process 910 only requires the participant to stand comfortably, with feet roughly shoulder-width apart, with hands hanging at sides not touching the body 140, for a front capture and a side capture as displayed in their respective frames 110 and 210. The entire processing time for these captures, excluding pauses for entering individual information, takes less than ten seconds. As a complete system, ADAM costs less than $1,500. For comparison, purchasing the anthropometer, which is otherwise required to take accurate manual measurements, costs approximately $3,000. Finally, the ADAM process 910 requires no subject matter expertise (SME) to use, whereas manual measurements benefit greatly from a SME's abilities and typically require specialized training.

When compared with the Phase I prototype, the ADAM process 910 shows marginal improvements in mean absolute error (accuracy). As a note, the accuracy numbers recorded in Phase I were already pushing the state-of-the-art for this technology when compared with other solutions. During Phase 11, the ADAM process 910 was able to improve accuracy to a level closer to other industry standards (Table 2 in FIG. 7B) but maintain the portability and size requirements.

Similar to Phase I, objective and threshold targets for accuracy were set. These targets and ADAM's tested accuracy values are provided (Table 3 in FIG. 7C). ADAM's reported mean absolute error achieved the minimum target for two of the five measures and fell with within 2 mm to 6 mm of the minimum target for the remaining measures. Note that the median difference is better than the average difference—this implies that the error distribution is skewed to the right and that the average is affected by larger error values.

Stature 455 was the most difficult measure to accurately predict. Several factors, including hair and head position, can affect how ADAM locates the head point and ultimately generates the stature prediction. Thumb-tip reach 450 also has a higher reported error, but was given more flexibility due to the flexibility of the shoulder joint leading to more inconsistency in manual measurements. By comparison, machine learning models and neural networks, industry leaders, such as Google and Microsoft, target accuracy levels of 90-95%. ADAM provides less than 2% error (>98% accuracy) for generating predictions.

The greatest success of Phase II, however, was in the consistency and reliability improvements. In this context, consistency is defined as the mathematical difference in predictions between two different attempts using the same person. For each measurement, ADAM is showing a consistency of less than 3 mm (Table 4 in FIG. 7D). Comparison of the reported ADAM consistency results with the system consistency requirements established early in the effort through conversations with NASC Pensacola. Additional image processing techniques were incorporated to assist in locating the individual within an image along with their correct joint locations on each attempt. In the rare occasion detecting joints is impeded, ADAM is able to detect the source and provide the operator with an option to try again rather than proceeding with predictions.

Readiness Level: The ending Technical Readiness Level (TRL) of the ADAM System is TRL-8, which is characterized by its ability to work successfully in its final form and under expected conditions. The ADAM System has run successfully at Naval Air Schools Command (NASC) in a near-complete state with minimal/low-impact issues that have been addressed. There are no additional objectives or goals currently planned for ADAM. Finally, developmental test and evaluation of the ADAM System has been completed and documented. For reference, Phase I of the project ended at TRL-6.

Deliverables: An ADAM System includes a ZED2 stereo camera and a laptop. The hardware requirements of the laptop are a NVIDIA GPU capable of supporting the ZED2 camera and minimum 8 GB random access memory (RAM). NSWC Dahlgren delivered five new systems to personnel at NASC Pensacola in phases from January 2021—July 2021. NASC Pensacola also had three older systems from Phase I. All systems were updated at the final demonstration on Jul. 6, 2021. In addition to these systems, NSWC Dahlgren delivered the ADAM software, installation instructions, and a user guide to NASC Pensacola.

Conclusions: Following a successful final demonstration, and subsequent user testing and usage, the ADAM System is capable of providing predicted measurements for the five target measurements: stature 455, sitting height 435, sitting eye height 440, buttock-knee length 445, and thumb-tip reach 450 for aiding in the qualification of a Student Naval Flight Officer (SNFO) or Student Naval Aviators (SNA) to fit into various aircraft. Operationally, an SNFO or SNA will not be disqualified solely based on the results of the ADAM System; if the ADAM System indicates aircraft restrictions based on the predicted measurements, the SNFO or SNA will be manually measured before being disqualified.

Effectively, the ADAM System reduces the frequency of required manual measurements to those that are on the edge of qualification or have predicted measurements that are indicated as restricted within the ADAM System. These conclusions are based on the results, which demonstrate that the ADAM prediction model lies within the acceptable error range for two measurements and just outside the allowable error range for the remaining three measurements, and from discussions with the customer and end-users at and after the final demonstration.

Transition: In its current state, ADAM has been delivered to the personnel at NASC Pensacola and is being incorporated into their daily routine. Future efforts associated with ADAM would be largely focused on publication and presentation at conferences to showcase the tool's capabilities. NASC personnel and NSWCDD researchers are planning to submit an abstract to Aerospace Medical Association (ASMA) annual conference in FY22.

Future development would involve adjusting ADAM to match alternative users. For example, the ADAM team plans to contact representatives in the U.S. Air Force to discuss integrating ADAM within their anthropometric measurement process. Additional data collection efforts may be needed to adjust to their requirements. In addition, NASC personnel have expressed interest in a compact version of ADAM for use at recruiting stations. Funding has not been acquired for these efforts as yet.

Outside of anthropometrics, this technology is being investigated for use in assisting 3D space design. NSWC Dahlgren has several groups involved in modeling ship spaces and providing human-based usability knowledge to generate a safe environment for the sailors. The underlying technology of ADAM has the potential to be applied towards movements within 3D space over time to provide quantitative data towards improving current spaces and assisting in the design of future spaces. A proposal has been submitted for this work but funding has not yet been acquired.

This project, in both phases, has been a great opportunity to work directly with and for the warfighter. It is evident in the final delivered product, that the end-user/customer had a significant (positive) impact on the design of the user interface, which ultimately aided in acceptance and confidence in the ADAM System which has led to its adoption and usage. The NSWCDD team intends to continue this effort in whichever form it takes next: there is a clear warfighter need for this type of work and its applicability to other, related projects is varied.

Comparative References: As indicated by the literature mentioned in the disclosure, intellectual property references also present developments in this anthropometric field. U.S. Pat. No. 10,321,728 and Japanese publication JP 2021/012707 extract body measurements but rely on two-dimensional (2D) imagery in contrast to ADAM, which employs 3D scans. Moreover, these references operate on body segmentation from background, in contrast to ADAM using pose estimation to identify location points irrespective of background. These references require a separate operator-supplied input such as height for proper scaling, whereas ADAM determines such parameters independently.

Russian patent publication RU 2009-12549914 requires five concurrently operated cameras calibrated specifically to intersect on optical axes at a point, and employs coherent radiation (e.g., from a laser) applied to the body. U.S. publication 2013/0179288 relies on reference data, such as input measurement, a specific object within the captured image or moving either the camera 970 or the body 140 for context. By contrast, ADAM captures a 3D point cloud without external references, and presents quantifiable dimensions, rather than subjective comparisons.

U.S. publication 2018/0096490 necessitates separate imagery of the background within that frame, as well as employing segmentation of the body and receipt of calibration input, such as distance from camera to body—operations that ADAM omits. IET Computer Vision presents analysis, and employs 2D images and requires calibration to map image coordinates to physical measurements by receipt of known distances to markers. See Insafutdinov for reference. By contrast, ADAM utilizes more accurate joint detection, requiring no marker or calibration.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A measurement system for assessing dimensions of a human body, said system comprising:
a stereoscopic camera for capturing an image of the body standing from front and side perspectives; and
an autonomous processor for identifying a plurality of reference points corresponding to extremity locations and joints on said image of the body and calculating distances between said reference points and determining the dimensions for output.

2. The system according to claim 1, wherein said autonomous processor further estimates a pose envelope from said distances.

3. The method according to claim 2, wherein said autonomous processor compares said pose envelope to confinement restraints for predicting anthropometric conformity to said restraints.

4. The method according to claim 1, further comprising an input device for manually providing non-optical information associated with the body.

5. A computer implemented method for assessing dimensions of a human body based on for stereoscopic photographic capture of an image of said body standing from front and side perspectives, said method comprising:
identifying a plurality of reference points corresponding to extremity locations and joints on said image of the body; and
calculating distances between said reference points and determining the dimensions for output.

6. The method according to claim 5, further including:
estimating a pose envelope from said distances;
calculating distances between said reference points; and
determining the dimensions for output.

7. The method according to claim 6, further including:
comparing said pose envelope to confinement restraints for predicting anthropometric conformity to said restraints.

8. A computer implemented method for assessing dimensions of a human body, said method comprising:
capturing a stereoscopic image of the body standing from front and side perspectives;
identifying a plurality of reference points corresponding to extremity locations and joints on said image of the body; and
calculating distances between said reference points and determining the dimensions for output.

9. The method according to claim 8, further including:
estimating a pose envelope from said distances;
calculating distances between said reference points; and
determining the dimensions for output.

10. The method according to claim 8, further including:
comparing said pose envelope to confinement restraints for predicting anthropometric conformity to said restraints.
